(19) United States
(12) Patent Application Publication
(10) Pub. No.: US 2010/0079795 A1
(43) Pub. Date: Apr. 1, 2010

(54) IMAGE FORMING APPARATUS, IMAGE FORMING METHOD, PROGRAM, AND STORAGE MEDIUM

(75) Inventor: Hiroshi Mori, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/559,692

(22) Filed: Sep. 15, 2009

(30) Foreign Application Priority Data
Sep. 30, 2008 (JP) 2008-255246

(51) Int. Cl. G06F 3/12

(52) U.S. Cl. 358/1.15

(57) ABSTRACT

An image forming apparatus includes an input unit which receives input of image data containing a plurality of drawing objects overlapping each other, a pixel data generation unit which generates a plurality of pixel data corresponding to the respective drawing objects, a pixel data compression unit which compresses the plurality of pixel data into pieces of run-length information corresponding to the plurality of pixel data, a selection unit which selects, based on drawing information of the drawing object, either of composition of the pixel data and composition of the run-length information to be performed, a pixel data composition unit which composites the pixel data, and a compressed pixel composition unit which composites the run-length information.

### BACKGROUND OF THE INVENTION

1. Field of the Invention

The present invention relates to an image forming apparatus, image forming method, program, and storage medium.

2. Description of the Related Art

These days, a variety of resource parallelization techniques have been proposed to increase the image processing speed. Particularly, a technique using a plurality of processors is proposed to parallel-execute processes and increase the processing speed. Data needs to be exchanged between a plurality of resources. For this purpose, there is proposed a technique of compressing data to reduce the communication load.

Complicated composition processing, transparent processing, and the like are becoming popular for higher image qualities of recent printers. For example, PDF available from Adobe and XPS available from Microsoft implement complicated transparent processing between objects, but require complex calculation processing.

In this technical background, for example, according to Japanese Patent Laid-Open No. 59-81961, object run-length information subjected to data communication is compressed and communicated. Overlapping of compressed objects is determined, and appropriate composition processing is done for a different overlapping state, calculating the overlapping result. The composition processing can be achieved without decompressing compressed data.

However, the conventional technique executes one type of composition processing for a different overlapping state, and cannot switch the composition processing in a region where the overlapping state remains unchanged. For example, when composition processing is performed for run-length information of multi-valued image data in a region where objects overlap each other, the calculated composition result remains unchanged even for a region where the color value changes. For this reason, the conventional technique cannot be applied.

### SUMMARY OF THE INVENTION

The present invention has been made to solve the conventional problems, and provides an image forming technique capable of performing composition processing optimum for different pieces of run-length information contained in a region where objects overlap each other.

According to one aspect of the present invention, there is provided an image forming apparatus comprising: an input unit configured to receive input of image data containing a plurality of drawing objects overlapping each other; a pixel data generation unit configured to generate a plurality of pixel data corresponding to the respective drawing objects received by the input unit; a pixel data compression unit configured to compress the plurality of pixel data generated by the pixel data generation unit into pieces of run-length information corresponding to the plurality of pixel data; a selection unit configured to select, based on drawing information of the drawing object, either of composition of the pixel data and composition of the run-length information to be performed; a pixel data composition unit configured to composite the pixel data based on the selection by the selection unit; and a compressed pixel composition unit configured to composite the run-length information based on the selection by the selection unit.

According to another aspect of the present invention, there is provided an image forming method in an image forming apparatus, the method comprises: an input step of receiving input of image data containing a plurality of drawing objects overlapping each other; a pixel data generation step of generating a plurality of pixel data corresponding to the respective drawing objects received in the input step; a pixel data compression step of compressing the plurality of pixel data generated in the pixel data generation step into pieces of run-length information corresponding to the plurality of pixel data; a selection step of selecting, based on drawing information of the drawing object, either of composition of the pixel data and composition of the run-length information to be performed; a pixel data composition step of superimposing the pixel data based on the selection in the selection step; and a compressed pixel composition step of superimposing the run-length information based on the selection in the selection step.

The present invention can perform composition processing optimum for different pieces of run-length information contained in a region where objects overlap each other.

The present invention can also select optimum composition processing regardless of the type of data and increase the image forming speed independently of the type of data.

Further features of the present invention will become apparent from the following description of exemplary embodiments with reference to the attached drawings.

### BRIEF DESCRIPTION OF THE DRAWINGS

FIG. 1 is a block diagram showing the schematic arrangement of an image forming system according to the first embodiment;

FIG. 2 is a sectional view for explaining the arrangement of a tandem type laser beam printer capable of color printing;

FIG. 3 is a block diagram for explaining the internal arrangement of a printer controller;

FIG. 4 is a block diagram showing the functional arrangement of an image forming apparatus according to the first embodiment;

FIG. 5 is a view for explaining the structures of rendering control information and run-length pixel data used in the image forming apparatus;

FIG. 6 is a flowchart for explaining details of pixel generation processing and run-length data generation processing by a pixel data generation unit and pixel data compression unit;

FIG. 7A is a flowchart for explaining details of image pixel generation processing in FIG. 6;

FIG. 7B is a view for explaining details of the image pixel generation processing in FIG. 6;

FIG. 8A is a flowchart for explaining details of gradation pixel generation processing in FIG. 6;

FIG. 8B is a view for explaining details of the gradation pixel generation processing in FIG. 6;

FIG. 9A is a flowchart for explaining details of composition processing by a compressed pixel composition unit and pixel data composition unit;

FIG. 9B is a view for explaining details of the composition processing by the compressed pixel composition unit and pixel data composition unit;

FIG. 10 is a flowchart for explaining details of composition mode discrimination processing by a composition processing selection unit;

FIG. 11A is a flowchart for explaining details of image composition selection processing;

FIG. 11B is a flowchart for explaining details of gradation composition selection processing;

FIG. 11C is an exemplary view for explaining the effect of the scaling ratio in the image composition selection processing;

FIG. 12 is a block diagram for explaining the internal arrangement of a printer controller in an image forming apparatus according to the second embodiment;

FIG. 13 is a block diagram for explaining the functional arrangement of the image forming apparatus according to the second embodiment;

FIG. 14 is a flowchart for explaining details of composition processing by a pixel data composition unit according to the second embodiment; and

FIG. 15 is a flowchart for explaining details of composition processing by a compressed pixel composition unit according to the second embodiment.

### DESCRIPTION OF THE EMBODIMENTS

Exemplary embodiments of the present invention will be described in detail below with reference to the accompanying drawings.

### Outline of Image Forming System

An example of applying the present invention to an image forming system having an information processing apparatus and image forming apparatus (printer) will be explained. The embodiment will exemplify a laser beam printer as the arrangement of a printer to which the present invention can be applied. However, the gist of the present invention is not limited to this example, and the present invention is also applicable to an inkjet printer or another type of printer. Software (program) to which the present invention is applicable is not exclusively applied to the information processing apparatus and image forming system. The software is widely applicable to wordprocessor software, spreadsheet software, graphic software, and the like.

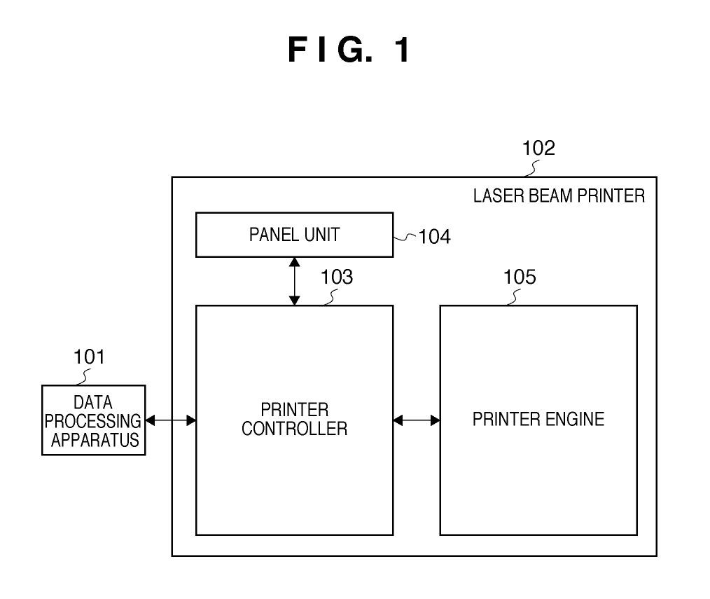

FIG. 1 is a block diagram showing the schematic arrangement of the image forming system according to the first embodiment. Referring to FIG. 1, a data processing apparatus 101 is, for example, an information processing apparatus (computer). The data processing apparatus 101 generates a control code for controlling the image forming apparatus having an image processing apparatus, and outputs (supplies) the control code to the image forming apparatus. The data processing apparatus 101 functions as a control apparatus for the image forming apparatus (a laser beam printer 102) capable of transmitting/receiving data to/from the data processing apparatus 101.

A printer controller 103 generates raster data for each page based on image information contained in the image forming apparatus control code (e.g., an ESC code, page description language, or band description language) supplied from the data processing apparatus 101. The printer controller 103 sends the raster data to a printer engine 105.

The printer engine 105 forms a latent image on a photosensitive drum based on the raster data supplied from the printer controller 103. The printer engine 105 transfers and fixes the latent image onto a print medium (by an electrophotographic method), printing the image.

A panel unit 104 is used as a user interface. The user manipulates the panel unit 104 to designate a desired operation. The panel unit 104 displays the processing contents of the laser beam printer 102 and the contents of a warning to the user.

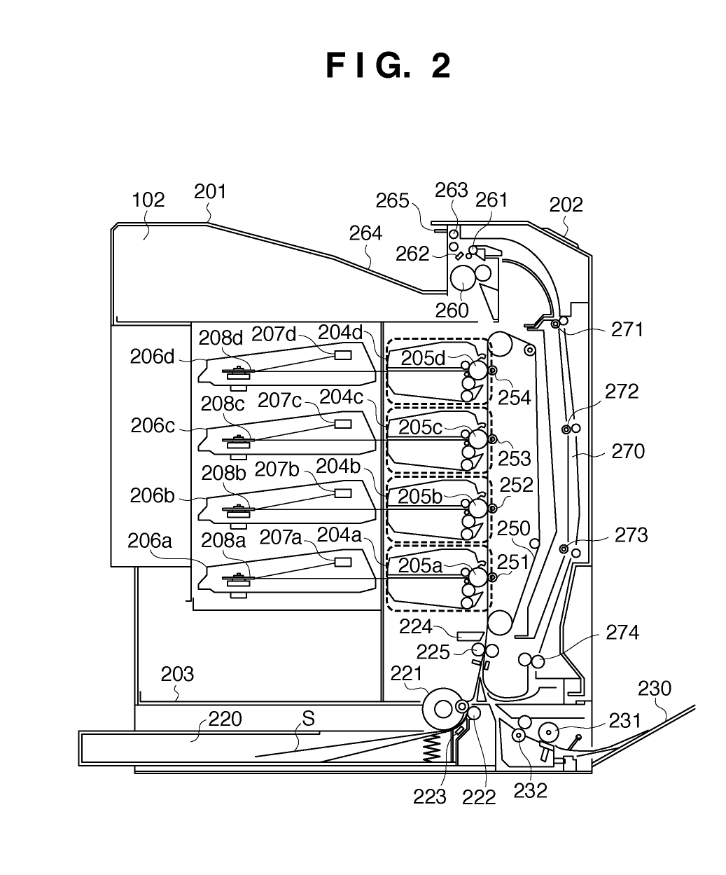

FIG. 2 is a sectional view for explaining the arrangement of the tandem type laser beam printer 102 capable of color printing. In FIG. 2, reference numeral 201 denotes a printer housing. An operation panel 202 includes switches for inputting various instructions, LED indicators, and LCD display for displaying messages, the setting contents of the printer, and the like. The operation panel 202 is an example of the panel unit 104 shown in FIG. 1. A board container 203 contains a board which constitutes the electronic circuits of the printer controller 103 and printer engine 105.

A paper cassette 220 holds sheets (print media) S, and has a mechanism of electrically detecting the paper size by a partition (not shown). A cassette clutch 221 includes a cam for picking up the top one of the sheets S in the paper cassette 220, and conveying the picked-up sheet S to a feed roller 222 by a driving force transmitted from a driving means (not shown). In every feeding, the cam rotates intermittently to feed one sheet S by one rotation. A paper detection sensor 223 detects the amount of sheets S in the paper cassette 220.

The feed roller 222 conveys the leading end of the sheet S to a registration shutter 224. The registration shutter 224 can stop the fed sheet S by pressing it.

Reference numeral 230 denotes a manual feed tray; and 231, a manual feed clutch. The manual feed clutch 231 is used to convey the leading end of the sheet S to a manual feed roller 232. The manual feed roller 232 is used to convey the leading end of the sheet S to the registration shutter 224. The sheet S used to print an image is fed by selecting either the paper cassette 220 or manual feed tray 230.

The printer engine 105 communicates with the printer controller 103 according to a predetermined communication protocol, and selects either the paper cassette 220 or manual feed tray 230 in accordance with an instruction from the printer controller 103. The printer engine 105 controls conveyance of the sheet S to the registration shutter 224 by the selected feed means in response to a print start instruction. The printer engine 105 includes a paper feed means, a mechanism associated with an electrophotographic process including formation, transfer, and fixing of a latent image, a paper discharge means, and a control means for them.

Image printing sections 204a, 204b, 204c, and 204d include photosensitive drums 205a, 205b, 205c, and 205d and toner storing units, and form toner images on the sheet S by an electrophotographic process. Laser scanner sections 206a, 206b, 206c, and 206d supply image information of laser beams to the corresponding image printing sections.

In the image printing sections 204a, 204b, 204c, and 204d, a plurality of rotating rollers 251 to 254 keep a paper conveyance belt 250 taut and flat in the paper conveyance direction (upward from the bottom in FIG. 2) to convey the sheet S. On the uppermost stream side, the sheet is electrostatically attracted to the paper conveyance belt 250 by attraction rollers 225 receiving a bias voltage. The four photosensitive drums 205a, 205b, 205c, and 205d are arranged in line to face the conveyance surface of the belt, constituting image forming means. In each of the image printing sections 204a, 204b, 204c, and 204d, a charger and developing unit are arranged around the photosensitive drum.

The laser scanner sections 206a, 206b, 206c, and 206d will be explained. Laser units 207a, 207b, 207c, and 207d emit laser beams by driving internal semiconductor lasers in accordance with an image signal (signal/VIDEO) sent from the printer controller 103. The laser beams emitted by the laser units 207a, 207b, 207c, and 207d are scanned by rotary polygon mirrors (rotary polyhedral mirrors) 208a, 208b, 208c, and 208d, forming latent images on the photosensitive drums 205a, 205b, 205c, and 205d. A fixing unit 260 thermally fixes, to the sheet S, toner images formed on the sheet S by the image printing sections 204a, 204b, 204c, and 204d. A conveyance roller 261 conveys the sheet S to discharge it. A paper discharge sensor 262 detects discharge of the sheet S. A roller 263 serves as a paper discharge roller and a roller for switching the conveyance path to the double-sided printing one. When the conveyance instruction of the sheet S is discharge, the roller 263 directly discharges the sheet S to a paper discharge tray 264. When the conveyance instruction is double-sided conveyance, the rotational direction of the roller 263 is reversed to switch back the sheet S immediately after the trailing end of the sheet S passes through the paper discharge sensor 262. Then, the roller 263 conveys the sheet S to a double-sided printing conveyance path 270. A discharged-paper stack amount detection sensor 265 detects the amount of sheets S stacked on the paper discharge tray 264.

The sheet S conveyed to the double-sided printing conveyance path 270 by the paper discharge roller & double-sided printing conveyance path switching roller 263 is conveyed again to the registration shutter 224 by double-sided conveyance rollers 271 to 274. Then, the sheet S waits for an instruction to convey it to the image printing sections 204a, 204b, 204c, and 204d. Note that the laser beam printer 102 is further equipped with optional units such as an optional cassette and envelope feeder.

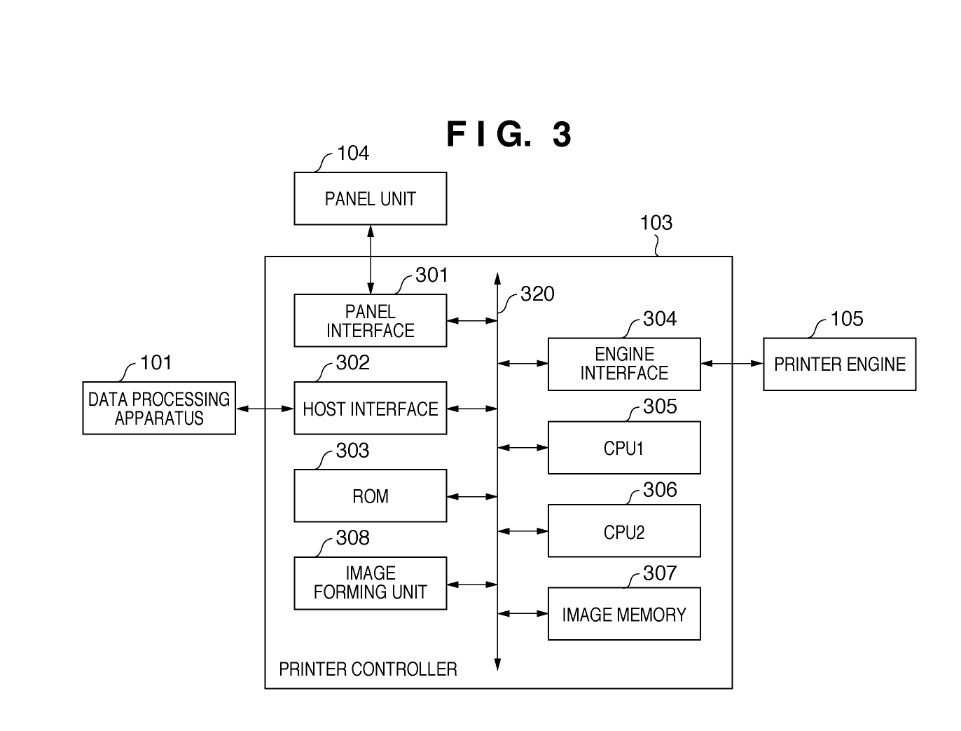

FIG. 3 is a block diagram for explaining the internal arrangement of the printer controller 103. Referring to FIG. 3, a panel interface 301 communicates data with the panel unit 104. A host interface 302 communicates in two ways with the data processing apparatus 101 such as a host computer via a network. The host interface 302 functions as an input means for receiving input of image data containing a plurality of drawing objects overlapping each other. A ROM 303 stores a program to be executed by a CPU 1 305 serving as the first CPU. An engine interface 304 communicates with the printer engine 105.

A CPU 2 306 serving as the second CPU can confirm, via the panel interface 301, contents set and designated by the user on the panel unit 104. The CPU 2 306 can also recognize the state of the printer engine 105 via the engine interface 304. The CPU 1 305 and CPU 2 306 can control devices connected to a CPU bus 320, based on control program codes stored in the ROM 303.

The CPU 1 305 and CPU 2 306 can load an image forming program into the image forming apparatus and execute processing to be described later.

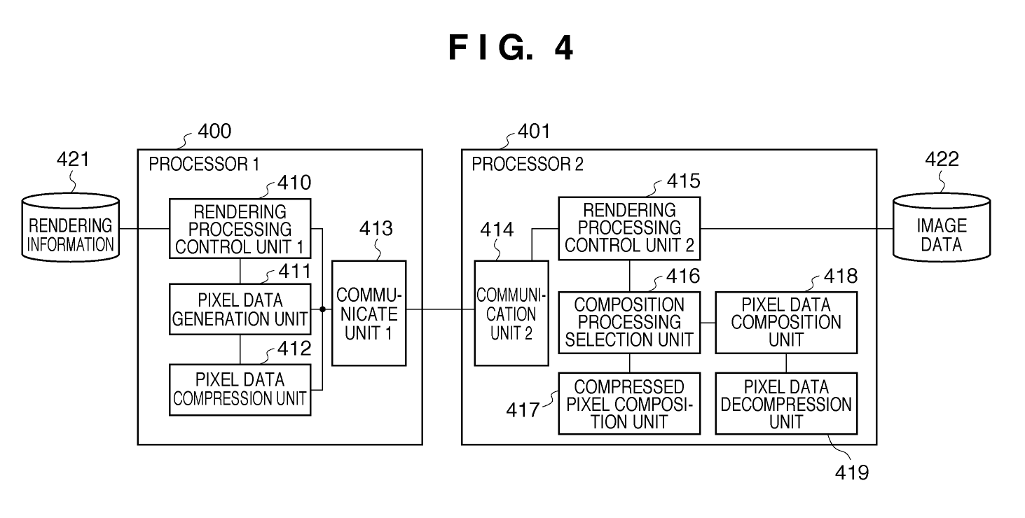

FIG. 4 is a block diagram showing the functional arrangement of the image forming apparatus according to the first embodiment. A program is loaded to construct, in the image forming apparatus, the functional arrangements of a processor 1 400 and processor 2 401 which can run under the control of the CPU 1 305 and CPU 2 306. An image memory 307 temporarily holds raster data generated by an image forming unit 308.

In the embodiment, a plurality of processors (processor 1 400 and processor 2 401) are series-connected.

The processor 1 400 includes a rendering processing control unit 1 410, pixel data generation unit 411, pixel data compression unit 412, and communicate unit 1 413.

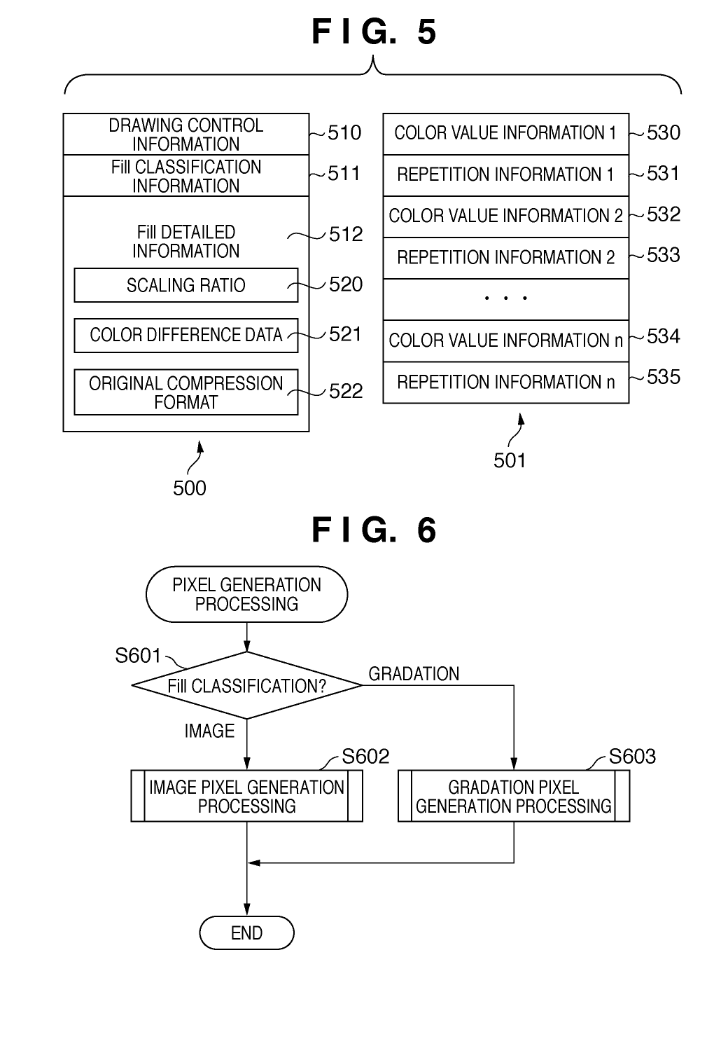

The rendering processing control unit 1 410 receives externally input rendering information 421 and operates based on the input rendering information 421. The rendering processing control unit 1 410 analyzes the rendering information 421 and based on the analysis result, generates rendering control information 500 (FIG. 5) as information for controlling the processor 2 401.

Based on the analysis result of the rendering information 421, the rendering processing control unit 1 410 instructs the pixel data generation unit 411 on pixel data generation processing.

The pixel data generation unit 411 performs pixel data generation processing in accordance with the instruction from the rendering processing control unit 1 410. The pixel data generation processing includes, for example, image scaling processing, and color difference addition processing for acquiring a gradation pixel. The pixel data generation unit 411 transfers the generated pixel data to the pixel data compression unit 412 and instructs it to generate run-length pixel data 501 (FIG. 5).

The pixel data compression unit 412 converts the pixel data transferred from the pixel data generation unit 411 into the run-length pixel data 501. As the compression method, repetition of the same color value is detected, and pixel data having the same color value are converted into run-length information.

The communicate unit 1 413 transfers, to the processor 2 401, the rendering control information 500 generated by the rendering processing control unit 1 410 and if necessary, the run-length pixel data 501 generated by the pixel data compression unit 412.

The processor 2 401 connected on the output of the processor 1 400 will be explained.

The processor 2 401 includes a communication unit 2 414, rendering processing control unit 2 415, composition processing selection unit 416, compressed pixel composition unit 417, pixel data composition unit 418, and pixel data decompression unit 419.

The rendering processing control unit 2 415 analyzes the rendering control information 500 acquired by the communication unit 2 414.

The rendering processing control unit 2 415 determines whether drawing control information 510 (FIG. 5) contains composition processing instruction information. If the drawing control information 510 contains composition processing instruction information, the rendering processing control unit 2 415 causes the composition processing selection unit 416 to select composition processing and execute the selected composition processing.

Upon receiving the instruction from the rendering processing control unit 2 415, the composition processing selection unit 416 analyzes Fill detailed information 512 and selects composition processing. For example, when the rendering information 421 represents “image”, the composition processing selection unit 416 analyzes a scaling ratio 520 and compares it with a scaling ratio threshold held in advance. If the scaling ratio is equal to or higher than the threshold, the composition processing selection unit 416 selects compressed pixel composition processing. The composition processing selection unit 416 instructs the compressed pixel composition unit 417 to composite the run-length pixel data 501 directly. Details of this processing will be described later.

Upon receiving the instruction from the composition processing selection unit 416, the compressed pixel composition unit 417 composites the run-length pixel data 501 directly. Details of this processing will be described later.

If the scaling ratio is lower than the threshold, the composition processing selection unit 416 selects pixel data composition processing. The composition processing selection unit 416 instructs the pixel data composition unit 418 to decompress run-length pixel data into pixel data and composite the pixel data for each pixel.

Upon receiving the instruction from the composition processing selection unit 416, the pixel data composition unit 418 transfers the received run-length pixel data to the pixel data decompression unit 419 and instructs it to decompress the run-length data into data of each pixel. The pixel data composition unit 418 composites the decompressed pixel data. Details of this processing will be described later.

Upon receiving the instruction from the pixel data composition unit 418, the pixel data decompression unit 419 decompresses the received run-length data into data of each pixel. The pixel data decompression unit 419 transfers the decompressed pixel data to the pixel data composition unit 418.

FIG. 5 is a view for explaining the structures of the rendering control information 500 and run-length pixel data 501 used in the image forming apparatus according to the embodiment of the present invention. The rendering control information 500 is used when the processor 1 400 issues a drawing instruction to the processor 2 401.

Fill classification information 511 represent the Fill classification of pixel data generated by the pixel data generation unit 411.

Fill detailed information 512 represents various parameters used in Fill drawing. Data held in the Fill detailed information 512 changes depending on the Fill classification information 511. When the Fill classification information 511 represents “image”, the Fill detailed information 512 holds the scaling ratio 520 indicating the scaling ratio of the image and an original compression format 522 indicating information of an original compression method. When the Fill classification information 511 represents “gradation”, the Fill detailed information 512 holds color difference data 521 indicating color gradation.

FIG. 6 is a flowchart for explaining details of pixel generation processing and run-length data generation processing by the pixel data generation unit 411 and pixel data compression unit 412.

In step S601, the pixel data generation unit 411 refers to the Fill classification information 511 to determine the Fill classification of pixel to be generated. If the Fill classification is “image”, the process advances to step S602 to perform image pixel generation processing. If the Fill classification is “gradation”, the process advances to step S603 to perform gradation pixel generation processing.

### Image Pixel Generation Processing

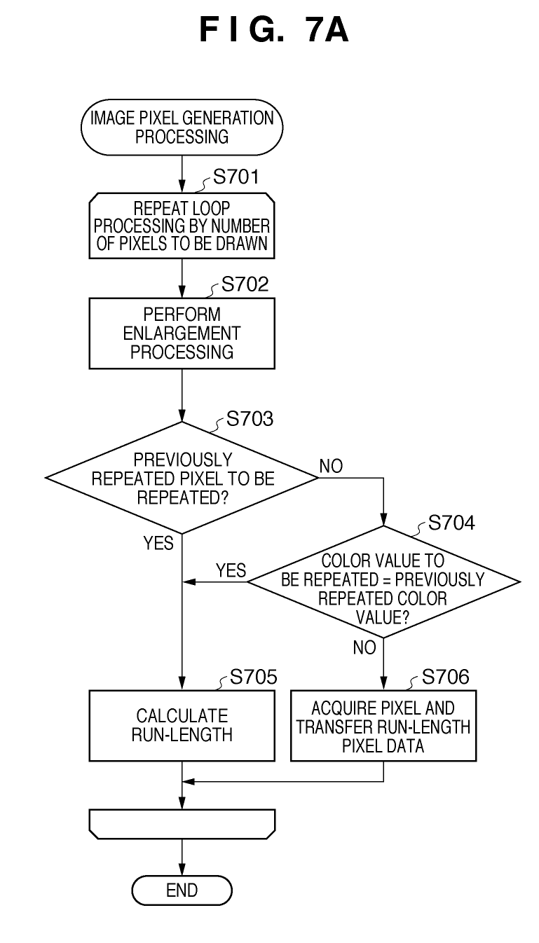

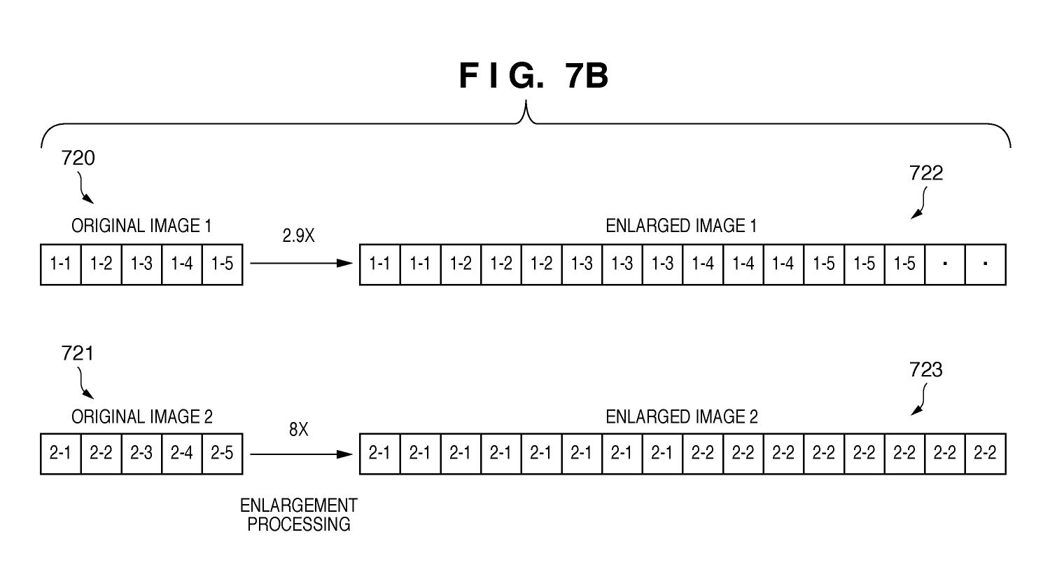

FIGS. 7A and 7B are a flowchart and view, respectively, for explaining details of the image pixel generation processing in FIG. 6.

In step S701, loop processing is done by the number of pixels to be drawn, generating a necessary number of image pixels.

In step S702, image enlargement processing is performed. In the enlargement processing, for example, when a scaling ratio of 2.9 is designated for an original image 1 720, as shown in FIG. 7B, a pixel of an original image from which the image is read out is determined. When processing the first pixel, it is determined to acquire pixel 1-1.

In step S703, it is determined whether to repeat a previously repeated pixel. For example, when processing the second pixel of an enlarged image 1 722 in FIG. 7B, it is determined that pixel 1-1 needs to be acquired this time, but pixel 1-1 has been read out last time, so the same pixel is repeated. In this way, it is determined whether to repeat a pixel, and if it is determined to repeat the pixel, the process advances to step S705. By this processing, repetitive pixels having the same characteristic are counted, and the minimum value of the repetition count is calculated from counting results. For example, pixels having the same color value are regarded as those having the same characteristic, and a minimum value is calculated. Composition processing is executed for the calculated minimum number of pixels.

If it is determined not to repeat the same pixel, the process advances to step S704.

In step S704, it is determined whether the color value (e.g., color value corresponding to RGB or CMYK) of a pixel to be repeated this time equals that of a previously processed pixel. For example, when processing the third pixel of the enlarged image 1 722 in FIG. 7B, pixel 1-2 is read out. At this time, when the color value of pixel 1-2 to be read out this time is equal to that of pixel 1-1 processed previously, the pixels can be expressed by the same run length. Hence, if it is determined that the color values coincide with each other, the process advances to step S705. If it is determined in step S704 that the color values are different from each other, the process advances to step S706.

In step S705, a run length RLE is calculated. At this time, an internally held run-length counter is incremented to calculate the repetition count.

In step S706, a pixel is acquired and run-length pixel data is transferred. The value of the internally held run-length counter is set in repetition information 1 531, repetition information 2 533, and repetition information n 535 of the run-length pixel data 501. The internal counter is then cleared to 0, and the run-length pixel data 501 is transferred to the communicate unit 1 413.

### Gradation Pixel Generation Processing

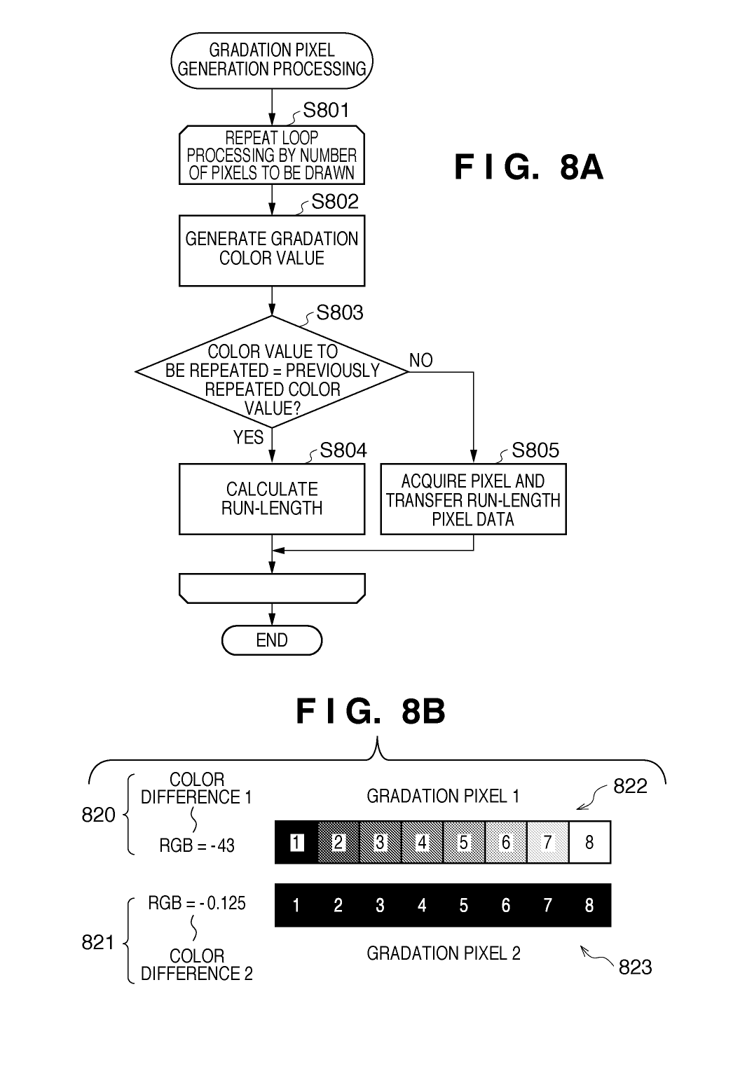

FIGS. 8A and 8B are a flowchart and view, respectively, for explaining details of the gradation pixel generation processing in FIG. 6.

In step S801, loop processing is done by the number of pixels to be drawn, generating a necessary number of gradation pixels.

In step S802, a gradation color value is generated. In this processing, the color value of the second pixel is generated by adding a color difference 1 820 to the color value of the first pixel, as represented by a gradation pixel 1 822 in FIG. 8B.

In step S803, it is determined whether to repeat a previously repeated pixel. For example, when processing the second pixel of a gradation pixel 2 823 in FIG. 8B, the integer part of an actually applied color value does not change because the color difference is smaller than 1. It is therefore determined to repeat a pixel of the same color value. In this manner, it is determined whether to repeat a pixel of the same color value. If it is determined to repeat a pixel of the same color value, the process advances to step S804. If it is determined not to repeat a pixel of the same color value, the process advances to step S805.

In step S804, the run length RLE is calculated. At this time, an internally held run-length counter is incremented to calculate the repetition count.

In step S805, a pixel is acquired and run-length pixel data is transferred. The value of the internally held run-length counter is set in the repetition information 1 531, repetition information 2 533, and repetition information n 535 of the run-length pixel data 501. The internal counter is then cleared to 0, and the run-length pixel data 501 is transferred to the communicate unit 1 413.

### Composition Processing

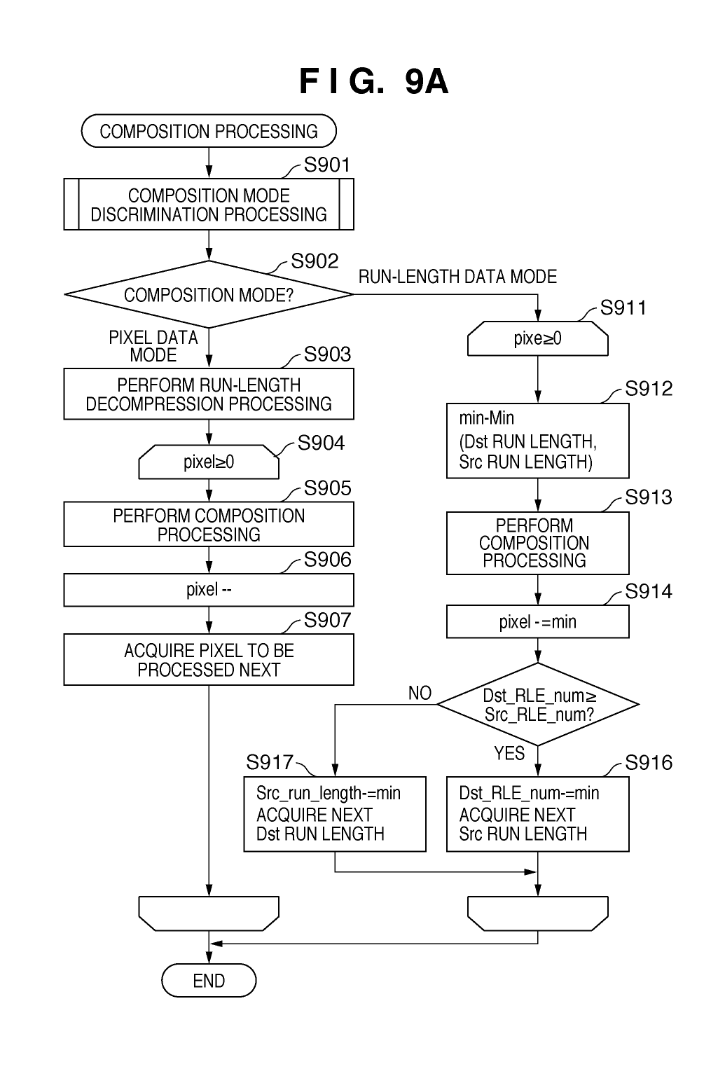

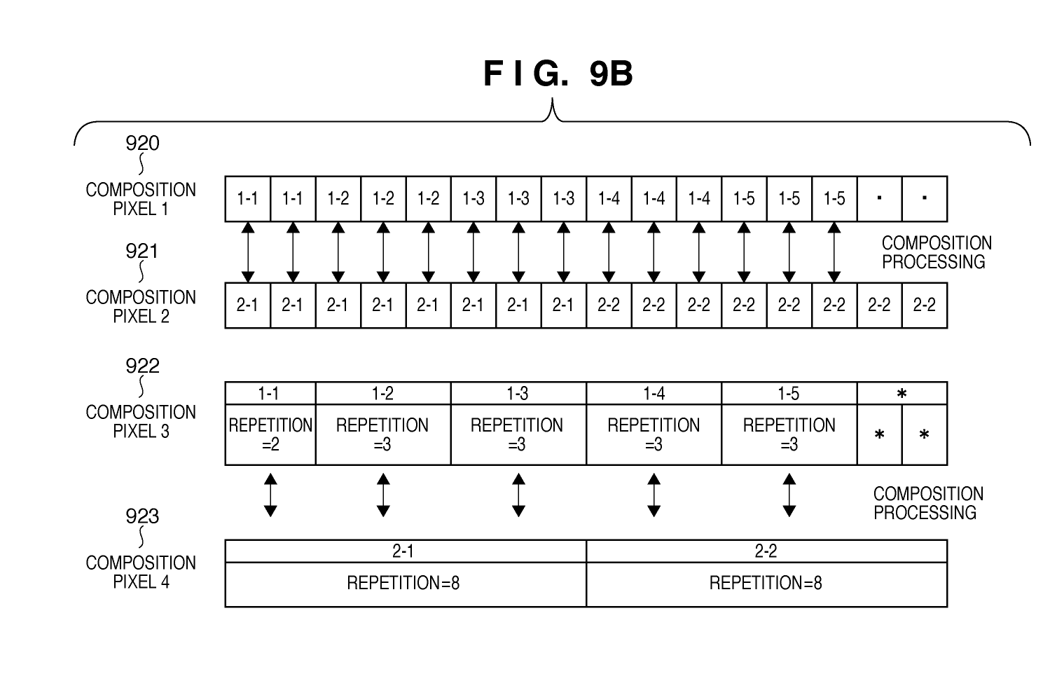

FIGS. 9A and 9B are a flowchart and view, respectively, for explaining details of composition processing by the compressed pixel composition unit 417 and pixel data composition unit 418.

In step S901, a composition processing method (composition processing mode) is selected. Based on the Fill detailed information 512, the composition processing selection unit 416 selects either compressed pixel composition processing or pixel data composition processing to be performed.

In step S902, processing to be executed is branched in accordance with the composition processing mode selected in step S901. If the composition processing selection unit 416 selects the pixel data composition processing (pixel data mode) in step S901, the process advances to step S903; if it selects the compressed pixel composition processing (run-length data mode), to step S911.

In step S903, run-length pixel data is decompressed. More specifically, a composition pixel 1 920 and composition pixel 2 921 in FIG. 9B which are transferred from the processor 1 400 are converted into a composition pixel 3 922 and composition pixel 4 923.

In step S904, composition processing is repeated by a necessary number of pixels.

In step S905, pixels are composited. For example, the composition pixel 3 922 and composition pixel 4 923 in FIG. 9B are composited as shown in FIG. 9B.

In step S906, the repetition count is decremented.

In step S907, Destination and Source pixels to be processed next are acquired.

In step S911, composition processing is repeated by a necessary number of pixels.

In step S912, a minimum value among the repetition counts of Destination run-length pixel data and Source run-length pixel data is acquired.

In step S913, run-length pixel data are composited. For example, the composition pixel 3 922 and composition pixel 4 923 in FIG. 9B are composited as shown in FIG. 9B.

In step S914, the repetition count is updated. In this case, run-length pixel data have been composited at once by a run length corresponding to a small repetition count. The repetition count of the processing is calculated by subtracting the minimum value of the repetition count.

In step S915, the Destination and Source run lengths are compared. If the Destination run length Dst_RLE_num is equal to or larger than the Source run length Src_RLE_num, the process advances to step S916. If the Source run length Src_RLE_num is larger, the process advances to step S917.

In step S916, the Destination run length Dst_RLE_num is set as a minimum value, and the remaining Destination run length is calculated. Since the composition processing of Source has ended, run-length pixel data representing the next Source is acquired.

In step S917, the Source run length Src_RLE_num is set as a minimum value, and the remaining Source run length is calculated. Since the composition processing of Destination has ended, run-length pixel data representing the next Destination is acquired.

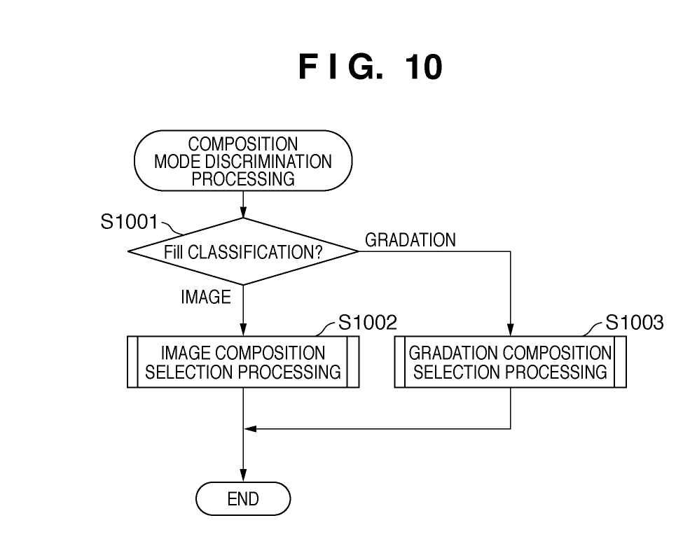

FIG. 10 is a flowchart for explaining details of the composition mode discrimination processing in S901 by the composition processing selection unit 416.

In step S1001, the composition processing selection unit 416 refers to the Fill classification information 511 to determine the Fill classification of pixel to be determined. If the Fill classification is “image”, the process advances to step S1002 to perform image composition selection processing. If the Fill classification is “gradation”, the process advances to step S1003 to perform gradation composition selection processing.

### Image Composition Selection Processing

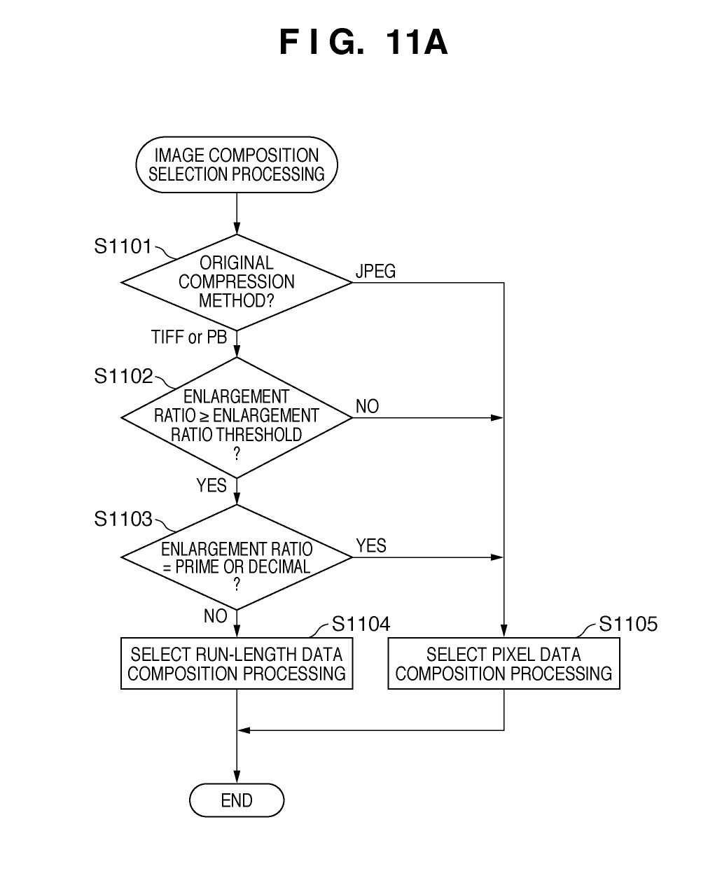

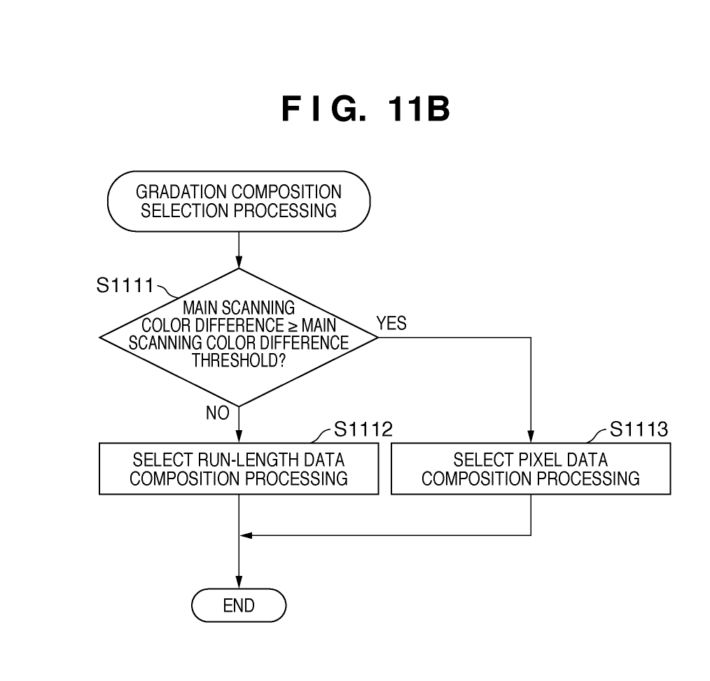

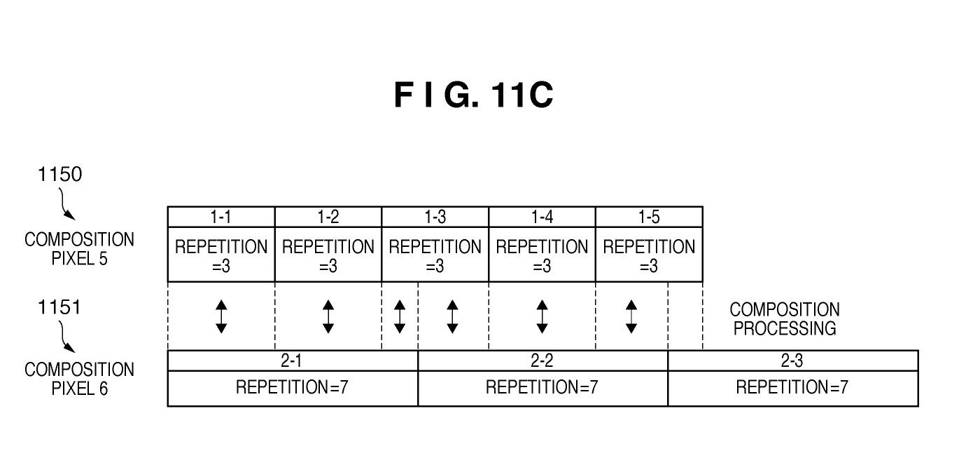

FIG. 11A is a flowchart for explaining details of the image composition selection processing in step S1002 of FIG. 10.

In step S1101, the original compression method of an image is determined. For example, when the original compression method is JPEG, an image often suffers noise, and even a region where the same color value is assumed to be repeated may contain a different color value. In this case, the effect of run-length compression described in the embodiment cannot be expected. Hence, the process advances to step S1105 to select pixel data composition processing.

When the compression method is Tiff or PB compression, an image is free from noise because of lossless compression, and the effect of run-length compression can be expected. In this case, the process advances to step S1102 to continue determination.

In step S1102, it is determined whether the pixel enlargement ratio is equal to or higher than a predetermined threshold (enlargement ratio threshold). If the pixel enlargement ratio is equal to or higher than the threshold, the process advances to step S1103 to continue determination. If the set enlargement ratio is lower than the enlargement ratio threshold, the process advances to step S1105 to select pixel data composition processing. If the set enlargement ratio is equal to or higher than the enlargement ratio threshold, the process advances step S1103.

In step S1103, it is determined whether the enlargement ratio is a prime or decimal. If the enlargement ratio is a prime, run-length pixel data to be composited may not match each other. For example, when the enlargement ratio is a prime, pixel 1-3 overlaps both pixels 2-1 and 2-2, as shown in FIG. 11C. Such a case occurs frequently, and the processing speed cannot be satisfactorily increased.

Making the determination in step S1103 avoids a mismatch between run-length pixel data. If the enlargement ratio is neither a prime nor decimal, the process advances to step S1104 to select run-length data composition processing. If it is determined in step S1103 that the enlargement ratio is a prime or decimal, the process advances to step S1105 to select pixel data composition processing.

### Gradation Composition Selection Processing

FIG. 11B is a flowchart for explaining details of the gradation composition selection processing in step S1003 of FIG. 10.

In step S1111, the color difference (main scanning color difference) between pixels in the main scanning direction that is contained in drawing information of a drawing object is compared with a predetermined threshold (main scanning color difference threshold). If the main scanning color difference is equal to or larger than the main scanning color difference threshold, the process advances to step S1113 to select pixel data composition processing.

If it is determined in step S1111 that the main scanning color difference is smaller than the main scanning color difference threshold, the process advances to step S1112 to select run-length data composition processing.

The first embodiment can perform composition processing optimum for different pieces of run-length information contained in a region where objects overlap each other.

The first embodiment can select optimum composition processing regardless of the type of data and increase the image forming speed independently of the type of data.

### Second Embodiment

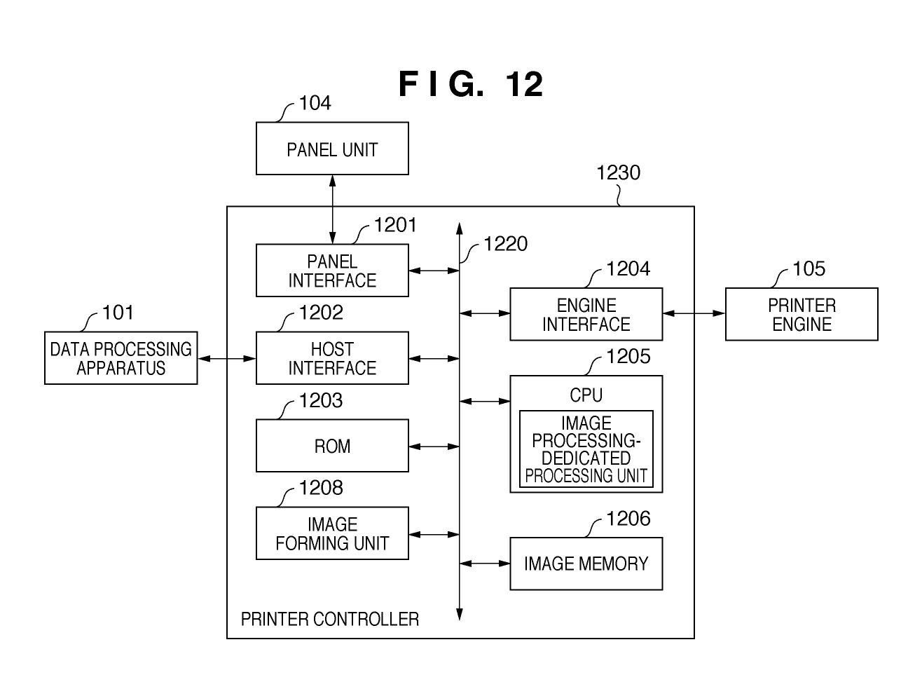

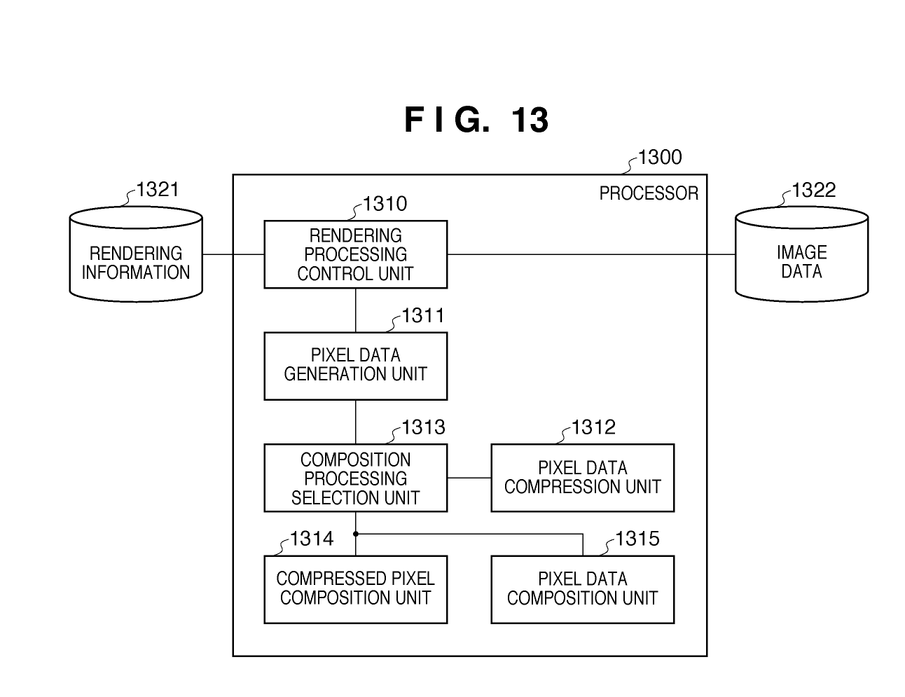

FIG. 12 is a block diagram for explaining the internal arrangement of a printer controller 1230 in an image forming apparatus according to the second embodiment.

Referring to FIG. 12, a panel interface 1201 communicates data with a panel unit 104.

A host interface 1202 communicates in two ways with a data processing apparatus 101 such as a host computer via a network.

A ROM 1203 stores a program to be executed by a CPU 1205. An engine interface 1204 communicates with a printer engine 105.

The CPU 1205 can confirm, via the panel interface 1201, contents set and designated by the user on the panel unit 104.

The CPU 1205 can also recognize the state of the printer engine 105 via the engine interface 1204.

The CPU 1205 can control devices connected to a CPU bus 1220, based on control program codes stored in the ROM 1203.

The CPU 1205 can load an image forming program into the image forming apparatus and execute image formation to be described later.

FIG. 13 is a block diagram for explaining the functional arrangement of the image forming apparatus according to the second embodiment. A program is loaded to construct, in the image forming apparatus, the functional arrangement of a processor 3 1300 which can run under the control of the CPU 1205 and an image processing-dedicated processing unit 1208.

An image memory 1206 temporarily holds raster data generated by an image forming unit 1207.

The image processing-dedicated processing unit 1208 can execute part of image processing performed by the image forming apparatus. The image processing-dedicated processing unit 1208 is dedicated to the CPU 1205. During image processing, if necessary, the CPU 1205 can execute image processing using the image processing-dedicated processing unit 1208. In the image forming apparatus of the second embodiment, a single processor 3 1300 performs processing.

A rendering processing control unit 1310 receives externally input rendering information 1321 and operates based on the input rendering information 1321. The rendering processing control unit 1310 analyzes the rendering information 1321 and if necessary, instructs a pixel data generation unit 1311 on pixel data generation processing based on the analysis result.

The pixel data generation unit 1311 performs pixel data generation processing in accordance with the instruction from the rendering processing control unit 1310. The pixel data generation processing includes, for example, image scaling processing, and color difference addition processing for acquiring a gradation pixel. More specifically, the processes shown in FIGS. 6, 7A, 7B, 8A, and 8B are executed.

In the pixel data generation processing, the image processing-dedicated processing unit 1208 can execute the processes of S701, S705, S706, S802, S804, and S805 in the second embodiment. In the processes of S701, S705, S706, S802, S804, and S805, the CPU 1205 invokes the image processing-dedicated processing unit 1208 to achieve the same processes as those described in the first embodiment.

A pixel data compression unit 1312 converts pixel data generated by the pixel data generation unit 1311 into run-length pixel data 501 in accordance with an instruction from a composition processing selection unit 1313. Upon receiving an instruction from the pixel data generation unit 1311, the composition processing selection unit 1313 analyzes Fill detailed information 512. The composition processing selection unit 1313 selects composition processing based on the analysis result, and if necessary, instructs the pixel data compression unit 1312 to compress pixel data generated by the pixel data generation unit 1311. For example, when the rendering information 1321 represents “image”, the composition processing selection unit 1313 analyzes a scaling ratio 520 and compares it with a predetermined threshold (enlargement ratio threshold). If the scaling ratio is equal to or higher than the enlargement ratio threshold, the composition processing selection unit 1313 selects compressed pixel composition processing. Details of this processing will be described later.

At this time, the composition processing selection unit 1313 instructs the pixel data compression unit 1312 to convert pixel data generated by the pixel data generation unit 1311 into the run-length pixel data 501. The composition processing selection unit 1313 instructs a compressed pixel composition unit 1314 to composite the run-length pixel data 501 directly. Details of this processing will be described later.

If the scaling ratio is lower than the enlargement ratio threshold, the composition processing selection unit 1313 selects a pixel data composition unit 1315. More specifically, the processes in FIGS. 10, 11A, and 11B are performed.

Upon receiving the instruction from the composition processing selection unit 1313, the compressed pixel composition unit 1314 composites the run-length pixel data 501 directly. Details of this processing will be described later.

Upon receiving the instruction from the composition processing selection unit 1313, the pixel data composition unit 1315 composites every pixel data generated by the pixel data generation unit 1311. Details of this processing will be described later.

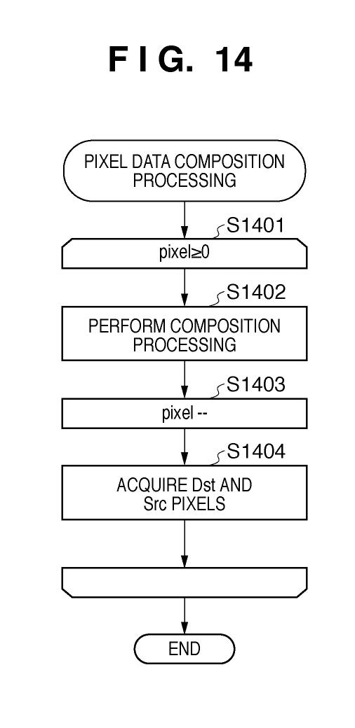

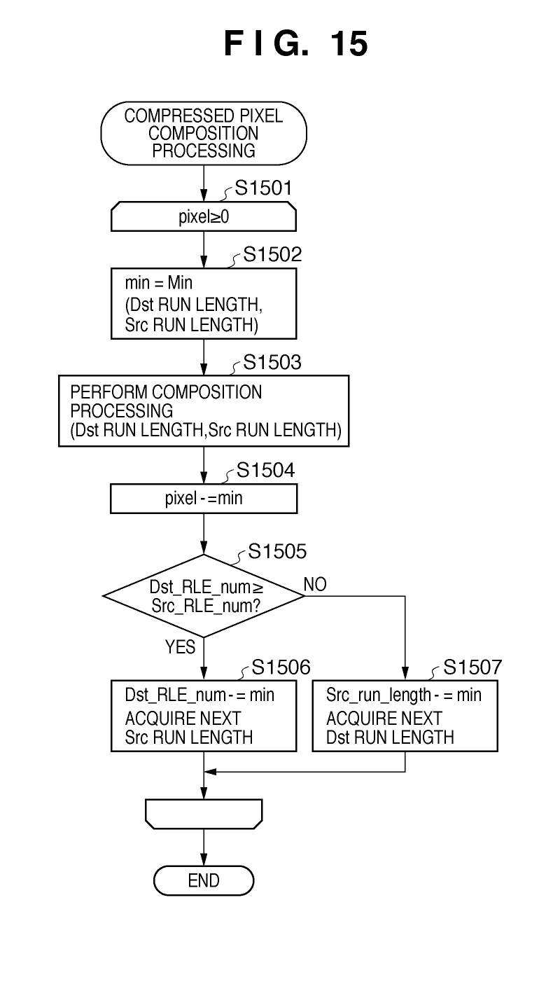

FIG. 14 is a flowchart for explaining details of composition processing by the pixel data composition unit 1315.

In step S1401, composition processing is repeated by a necessary number of pixels. In step S1402, pixels are composited. For example, in composition processing for a composition pixel 1 920 and composition pixel 2 921 in FIG. 9B, corresponding pixels are composited as shown in FIG. 9B. The image processing-dedicated processing unit 1208 can execute this processing.

In step S1403, the repetition count is decremented.

In step S1404, Destination (Dst) and Source (Src) pixels to be processed next are acquired.

FIG. 15 is a flowchart for explaining details of the composition processing by the compressed pixel composition unit 1314.

In step S1501, composition processing is repeated by a necessary number of pixels.

In step S1502, a minimum value among the repetition counts of Destination (Dst) run-length pixel data and Source (Src) run-length pixel data is acquired.

In step S1503, the run-length pixel data are composited. For example, in composition processing for a composition pixel 3 922 and composition pixel 4 923 in FIG. 9B, corresponding pixels are composited as shown in FIG. 9B. The image processing-dedicated processing unit 1208 can execute this processing.

In step S1504, the repetition count is updated. In this case, run-length pixel data have been composited at once by a run length corresponding to a small repetition count. The repetition count of the processing is calculated by subtracting the minimum value of the repetition count.

In step S1505, the Destination and Source run lengths are compared. If the Destination run length Dst_RLE_num is equal to or larger than the Source run length Src_RLE_num, the process advances to step S1506. If the Source run length Src_RLE_num is larger, the process advances to step S1507.

In step S1506, the Destination run length Dst_RLE_num is set as a minimum value, and the remaining Destination run length is calculated. Since the composition processing of Source has ended, run-length pixel data representing the next Source is acquired.

In step S1507, the Source run length Src_RLE_num is set as a minimum value, and the remaining Source run length is calculated. Since the composition processing of Destination has ended, run-length pixel data representing the next Destination is acquired.

The second embodiment can perform composition processing optimum for different pieces of run-length information contained in a region where objects overlap each other.

The second embodiment can select optimum composition processing regardless of the type of data and increase the image forming speed independently of the type of data.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-255246, filed Sep. 30, 2008, which is hereby incorporated by reference herein in its entirety.

What is claimed is:

1. An image forming apparatus comprising:
an input unit configured to receive input of image data containing a plurality of drawing objects overlapping each other;
a pixel data generation unit configured to generate a plurality of pixel data corresponding to the respective drawing objects received by said input unit;
a pixel data compression unit configured to compress the plurality of pixel data generated by said pixel data generation unit into pieces of run-length information corresponding to the plurality of pixel data;
a selection unit configured to select, based on drawing information of the drawing object, either of composition of the pixel data and composition of the run-length information to be performed;
a pixel data composition unit configured to composite the pixel data based on the selection by said selection unit; and
a compressed pixel composition unit configured to composite the run-length information based on the selection by said selection unit.

2. The apparatus according to claim 1, further comprising a calculation unit configured to count repetitive pixels having the same characteristic in the pieces of run-length information and calculate a minimum value from results of the counting,
wherein said compressed pixel composition unit composites the run-length information by pixels corresponding to the minimum value calculated by said calculation unit.

3. The apparatus according to claim 2, wherein said calculation unit calculates the minimum value by regarding pixels having the same color value as pixels having the same characteristic.

4. The apparatus according to claim 1, wherein
when a scaling ratio of the drawing object that is contained in the drawing information is not lower than a predetermined threshold, said selection unit selects compressed pixel composition processing, and
when the scaling ratio is lower than the predetermined threshold, said selection unit selects pixel data composition processing.

5. The apparatus according to claim 1, wherein
when a color difference between pixels in a main scanning direction that is contained in the drawing information is not smaller than a predetermined threshold, said selection unit selects pixel data composition processing, and
when the color difference in the main scanning direction is smaller than the predetermined threshold, said selection unit selects compressed pixel composition processing.

6. The apparatus according to claim 1, wherein
when a compression method set in the drawing information is JPEG, said selection unit selects pixel data composition processing, and
when the compression method is either of Tiff and PB, said selection unit selects compressed pixel composition processing.

7. The apparatus according to claim 1, further comprising a decompression unit configured to perform decompression processing of decompressing the run-length information into pixel data,
wherein said pixel data composition unit composites the pixel data decompressed by said decompression unit.

8. An image forming method in an image forming apparatus, the method comprising:
an input step of receiving input of image data containing a plurality of drawing objects overlapping each other;
a pixel data generation step of generating a plurality of pixel data corresponding to the respective drawing objects received in the input step;
a pixel data compression step of compressing the plurality of pixel data generated in the pixel data generation step into pieces of run-length information corresponding to the plurality of pixel data;
a selection step of selecting, based on drawing information of the drawing object, either of composition of the pixel data and composition of the run-length information to be performed;
a pixel data composition step of superimposing the pixel data based on the selection in the selection step; and
a compressed pixel composition step of superimposing the run-length information based on the selection in the selection step.

9. The method according to claim 8, further comprising a calculation step of counting repetitive pixels having the same characteristic in the pieces of run-length information and calculating a minimum value from results of the counting,
wherein in the compressed pixel composition step, the run-length information is composited by pixels corresponding to the minimum value calculated in the calculation step.

10. The method according to claim 9, wherein in the calculation step, the minimum value is calculated by regarding pixels having the same color value as pixels having the same characteristic.

11. The method according to claim 8, wherein in the selection step,
when a scaling ratio of the drawing object that is contained in the drawing information is not lower than a predetermined threshold, compressed pixel composition processing is selected, and
when the scaling ratio is lower than the predetermined threshold, pixel data composition processing is selected.

12. The method according to claim 8, wherein in the selection step,
when a color difference between pixels in a main scanning direction that is contained in the drawing information is not smaller than a predetermined threshold, pixel data composition processing is selected, and
when the color difference in the main scanning direction is smaller than the predetermined threshold, compressed pixel composition processing is selected.

13. The method according to claim 8, wherein in the selection step,
when a compression method set in the drawing information is JPEG, pixel data composition processing is selected, and
when the compression method is either of Tiff and PB, compressed pixel composition processing is selected.

14. The method according to claim 8, further comprising a decompression step of performing decompression processing of decompressing the run-length information into pixel data,
wherein in the pixel data composition step, the pixel data decompressed in the decompression step is composited.

15. A program which is stored in a computer-readable storage medium to cause a computer to execute an image forming method defined in claim 8.

16. A computer-readable storage medium storing a program defined in claim 15.

17. An image forming apparatus which receives image data containing a plurality of drawing objects and performs image forming processing based on the input image data, the apparatus comprising:
a generation unit configured to generate pixel data of the drawing objects;
a compression unit configured to compress the pixel data generated by said generation unit into pieces of run-length information;
a calculation unit configured to calculate a minimum value of repetition information from the pieces of run-length information; and
a composition unit configured to composite the pieces of run-length information by pixels corresponding to the minimum value calculated by said calculation unit.
